(19) United States
(12) Patent Application Publication
(10) Pub. No.: US 2011/0045979 A1
(43) Pub. Date: Feb. 24, 2011

(54) AGRICULTURALLY ACTIVE COMPOSITION COMPRISING A POLYCARBOXYLATE

(75) Inventor: Valerio Bramati, Arese (IT)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Rhodia Operations

(21) Appl. No.: 12/934,881

(22) PCT Filed: Mar. 30, 2009
(86) PCT No.: PCT/EP09/53717

§ 371 Date: Oct. 22, 2010

Related U.S. Application Data
(60) Provisional application No. 61/040,320, filed on Mar. 28, 2008.

(51) Int. Cl. A01N 57/20; A01P 13/00

(52) U.S. Cl. 504/206

(57) ABSTRACT

The present invention relates to agriculturally active compositions, such as herbicidal compositions, comprising an agriculturally active compound, such as a herbicide compound, for example an aminophosphate or aminophosphonate salt. The compositions of the invention comprise a polycarboxylate compound.

### BACKGROUND OF THEN INVENTION

The present invention relates to agriculturally active compositions, such as herbicidal compositions, comprising an agriculturally active compound, such as a herbicide compound, for example an aminophosphate or aminophosphonate salt.

One often uses additives in compositions comprising agriculturally active compounds. Some additives can help in allowing usage of the active and delivery from a concentrate from to a diluted form. Some additives are known as enhancing the activity of agriculturally active compounds. For example several patents describe the use of some surfactants to enhance the herbicidal activity of glyphosate.

There is a need in new agricultural additives that can easily be introduced in agriculturally active compositions, that can provide good formulation properties such as low foaming, good dispersability, and/or good stability, and/or that can provide enhancement of agricultural activity of active compounds. There is also a need in agriculturally active compositions that comprise such additives. There is for example a need in compositions that are surfactant-free or that comprise a reduced amount of surfactants, while preserving an interesting agricultural activity.

### BRIEF SUMMARY OF THE INVENTION

The invention addresses at least one of the needs above by providing an agriculturally active composition comprising:

an agriculturally active compound, preferably a herbicide compound, and

a polycarboxylate compound.

The invention also concerns the use of the polycarboxylate compound in agriculturally active compositions. The invention also relates to the use of the composition.

### DETAILED DESCRIPTION OF THE INVENTION

### Definitions

In the present specification, unless otherwise provided, the amounts of agriculturally active compounds, such as herbicide compounds, are provided as weight amounts. Unless otherwise provided, if the agriculturally active compound, for example the herbicide compound, can exist in acid or salt forms, the amounts are provided as acid equivalents.

The active can be for example a herbicide, a fungicide, an insecticide, a pesticide, a fertilizer. The active can be a water-soluble active. Examples of active compounds include Clopyralid, Imazethapyr, Paraquat, Dicamba, Bentazone, glyphosate, gluphosinate.

According to a preferred embodiment the active compound in a herbicide. Examples of herbicides include aminophosphate or an aminophosphonate compounds, in an acid or salt form. Such compounds can be for example glyphosate or gluphosinate, in an acid or salt form. Glyphosate refers to N-(phosphonomethyl)glycine. Gluphosinate refers to 4-[hydroxy(methyl)phosphinoyl]-DL-homoalanine.

Aminophosphate or aminophosphonate salts are known by the one skilled in the art. Preferred salts are glyphosate or gluphosinate salts. Useful salts include:

sodium (Na) salts;

potassium (K) salts;

ammonium salts having N(R)₄⁺ cations wherein R groups, identical or different, represent a hydrogen atom or a linear or non linear, saturated or unsaturated C₁-C₆ hydrocarbon group optionally substituted by a hydroxyl group, for example isopropylamine salts;

sulphonium salts; said salts being present alone or in a combination, and

mixtures or associations thereof.

Ammonium salts that can in particular be cited include salts obtained from secondary or primary amines such as isopropylamine (IPA), dimethylamine, diamines such as ethylenediamine, or alkanolamines such as monoethanolamine (MEA). Trimethylsulphonium is a perfectly suitable sulphonium salt.

Preferred glyphosate salts for herbicidal application that can be cited are isopropylamine (IPA—or “isopropylammonium”) salt, monoethanolamine (MEA) salt, trimethylsulphonium salt, potassium salt, ammonium salt, and mixtures or associations thereof, for example as taught in documents WO01/26469 (Nufarm) and WO03/013241 (Nufarm). Advantageously the aminophosphate or aminophosphonate salt comprises at least 10% by weight, preferably at least 50%, preferably at least 90%, of isopropylammonium aminophosphate or aminophosphonate salt, such as isopropylammonium glyphosate, or of potassium aminophosphate or aminophosphonate salt, such as potassium glyphosate salt.

Particularly useful actives are potassium glyphosate, isopropyl ammonium glyphosate, or ammonium gluphosinate.

The salt can be formed upon preparation of the composition by adding whole or a part of the total aminophosphate or aminophosphonate in acid form, and neutralizing to form the salt with the corresponding amount of base (such as KOH, amine etc). If only a part has been introduced and prepared, then the remaining can be added wholly or as parts.

### Polycarboxylate

The polycarboxylate is a polymer (including oligomers) comprising units that have carboxylic moieties. Such polymers comprise of course more than two carboxylic moieties. They typically comprise more than 10 carboxylic moieties. The number of carboxylic moieties varies with the molecular weight.

In the present application carboxylic moieties encompass various forms such as the acid form (group —COOH), salt forms (carboxylate group —COO⁻ X⁺, where X⁺ is a counter ion), the condensed form (anhydride group). In the polycarboxylate, several forms of the carboxylic moieties can co-exist. For example an acidic form and a salt form can co-exist, the different amounts thereof varying upon varying the pH and/or performing partial neutralization of the acid with a basic compound to form a salt. For example all or a part of the carboxylic moieties are in a salt form with sodium and/or potassium cations. Condensed anhydride forms can co-exist with acidic and/or salt forms (different amounts thereof can also vary with the pH and/or with performing neutralization).

The polycarboxylate is typically a polymer having a polymeric backbone and carboxylic side moieties. Said carboxylic side moieties are typically in acid form and/or in a salt form, and/or in a condensed anhydride form. The polymeric backbone is preferably a hydrocarbon chain. Such a backbone can be obtained by polymerizing ethylenically unsaturated monomers, such as olefin monomers, vinyl monomers, acrylic monomers, methacrylic monomers, acrylamido monomers, methacrylamide monomers.

The carboxylic side moieties can be obtained by polymerizing monomers comprising a carboxylic moiety and a polymerizable group such as an ethylenic insaturation, for example acrylic monomers or methacrylic monomers, or by copolymerizing such monomers with non carboxylic monomers. The carboxylic side moieties can also be obtained by chemically modifying side groups of a polymer or copolymer. For example carboxylic moieties can be obtained by hydrolyzing ester groups. Such a hydrolysis can be total or partial. Units corresponding to (meth)acrylic acid units or a salt thereof can be for example obtained by hydrolyzing ethyl or tertiobutyl (meth)acrylic units.

The polycarboxylate can be for example obtained by polymerizing or copolymerizing the following monomers:

Ethylenically unsaturated mono-carboxylic acids, in acid and/or salt form,

Ethylenically unsaturated di-carboxylic acids, in acid and/or salt form,

Ethylenically unsaturated anhydrides,

mixtures or associations thereof.

Examples of such monomers include, acrylic acid, methacrylic acid, α-ethacrylic acid, β,β-dimethylacrylic acid, methylenemalonic acid, vinylacetic acid, allylacetic acid, ethylidineacetic acid, propylidineacetic acid, crotonic acid, maleic acid, maleic anhydride, fumaric acid, itaconic acid, citraconic acid, mesaconic acid, and salt forms thereof, for example sodium and/or potassium salts thereof.

Non carboxylic monomers that can be copolymerized include for example acrylamide, vinyl alcohol, C₁-C₄ alkyl esters of acrylic acid and of methacrylic acid, C₁-C₄ hydroxyalkyl esters of acrylic acid and of methacrylic acid, especially ethylene glycol and propylene glycol acrylate and methacrylate, polyalkoxylated esters of acrylic acid and of methacrylic acid, especially the polyethylene glycol and polypropylene glycol esters, esters of acrylic acid or of methacrylic acid and of polyethylene glycol or polypropylene glycol mono(C₁-C₂₅)alkyl ethers, vinyl acetate, vinylpyrrolidone and methyl vinyl ether.

It is mentioned that the polycarboxylates that can be used can be at least partially cross-linked, for example by reacting the side carboxylic moieties with a cross linking agent comprising at least two groups than can react with the carboxylic moieties, such as —OH groups. For example one can use polycarboxylates partially cross linked with ethylene glycol.

If the polycarboxylate is a copolymer, it is preferred that the non carboxylic units and/or the amounts thereof are such that the polycarboxylate be water-soluble.

In some embodiments the polycarboxylate can be substantially free (less than 10 mol %, preferably less than 5 mol %, preferably less than 1 mol %) of:

units bearing sulfate or sulfonate groups (such as units deriving from AMPS monomer)

cationic units, and/or

hydrophobic units such as alkylesters of (meth)acrylic acid, styrene or di-isobutylene, vinyl acetate.

In one embodiment the polycarboxylate polymer comprises at least 50 mol %, preferably at least 75 mol %, preferably at least 90 mol %, preferably at least 95 mol % of units corresponding to the following monomers:

Ethylenically unsaturated mono-carboxylic acids, in acid and/or salt form,

Ethylenically unsaturated di-carboxylic acids, in acid and/or salt form,

Ethylenically unsaturated anhydrides,

mixtures or associations thereof.

In a preferred embodiment the polycarboxylate polymer comprises at least 50 mol %, preferably at least 75 mol %, preferably at least 90 mol %, preferably at least 95 mol % of units corresponding to acrylic acid and/or methacrylic acid, in acid or salt form. The polycarboxylate can be for example sodium polyacrylate or potassium polyacrylate.

The polycarboxylate can have a molecular weight of from 1 to 5 kg/mol, or from higher than 5 to lower than 10 kg/mol, or from 10 to 50 kg/mol, or from higher than 50 to 100 kg/mol, or from higher than 100 to 200 kg/mol, or from higher than 200 to 300 kg/mol, or from higher than 300 to 500 kg/mol, or from higher than 500 to 750 kg/mol, or from higher than 750 to 1000 kg/mol, or from higher than 1000 to 1500 kg/mol, or from higher than 1500 to 2000 kg/mol, or from higher than 2000 to 3000 kg/mol, or from higher than 3000 to 5000 kg/mol, or from higher than 3000 to 5000 kg/mol, or from higher than 5000 to 10000 kg/mol, or of higher than 10000 kg/mol. Such molecular weights can be weight-average (Mw) or number-average (Mn) molecular weights.

### Compositions

The composition of the invention can be in a solid or liquid concentrate form comprising at least 1%, preferably at least 10% by weight of active compound(s). Such concentrates are usually intended to be diluted before use.

The composition can be an aqueous composition, wherein the active compound is present in a solution or suspension form. In one embodiment the active is water-soluble and is present in a solution form in a water-based liquid medium. In one embodiment the polycarboxylate is water-soluble and is present in a solution form in a water-based liquid medium.

In a particular embodiment the composition is a liquid aqueous concentrate comprising at least 100 g/L as acid equivalent of an aminophosphate or an aminophosphonate salt present in a solution form in an aqueous medium.

The weight ratio between the active compound and the polycarboxylate can be for example of from 1/2 to 100/1, preferably of from 1/1 to 50/1, preferably of from 2/1 to 10/1.

In a particular embodiment the composition is a liquid aqueous concentrate comprising:

at least 360 g/L of aminophosphate or aminophosphonate salt, preferably at least 450 g/L, preferably at least 510 g/L, preferably at least 525 g/L, for example equal to 540 g/L±5%,

and at least 20 g/L, preferably at least 30 g/L, preferably at least 40 g/L, preferably at least 50 g/L of the polycarboxylate, and

water.

In a particular embodiment the composition is a liquid aqueous concentrate comprising:

from 360 g/L to 560 g/L of glyphosate salt, preferably of potassium glyphosate or isopropyl ammonium glyphosate, and

from 20 to 200 g/L, preferably from 40 to 100 g/L of the polycarboxylate, preferably of sodium polyacrylate or potassium polyacrylate.

In a particular embodiment the composition is a liquid aqueous concentrate comprising:

from 50 g/L to 300 g/L, preferably from 100 to 250 g/L, of gluphosinate salt, preferably of ammonium gluphosinate, and

from 20 to 300 g/L, preferably from 50 to 150 g/L of the polycarboxylate, preferably of sodium polyacrylate or potassium polyacrylate.

In one embodiment, the composition is substantially free of surfactant (less than ⅕th by weight of surfactant with reference to the weight of active, preferably less than 1/10th, preferably less than 1/50th, and/or less than 5% by weight, preferably less than 1%, preferably less than 0.1% with reference to the weight of the composition).

In one embodiment, the invention provides a surfactant free aqueous composition of a glyphosate salt, for example a potassium, IPA, MEA, NH₄⁺ or a mixture thereof, in an amount of higher than 360 g/L acid equivalent, preferably of higher than 440 g/L, preferably of higher than 470 g/L, preferably of higher than 500 g/L, preferably of higher than 530 g/L, for example in an amount of 450 g/L, 480 g/L, 510 g/L, or 540 g/L.

In one embodiment, the composition further comprises a surfactant.

### Further Ingredients

The composition of the invention can comprise further ingredients, such as:

surfactants,

anti-foaming agents,

solvents, preferably water miscible solvent, preferably polar solvents,

suspending and/or dispersing agents,

humectants and/or

deposition control agents such as anti-rebound or anti-drift agents, optionally added afterward.

Useful surfactants are known in the art. The surfactant can be selected in view of the form of the formulation and/or in view of the specific active. Useful associations of some active and some surfactants have been described in the art. The surfactant can help in stabilizing the composition and/or in further enhancing the activity.

The surfactant can for example be selected from the group consisting of:

amine or etheramine surfactants, optionally polyalkoxylated,

betaines surfactants

mono or polygycoside surfactants, optionally polyalkoxylated,

amine oxides surfactants

cationic surfactants.

phosphate esters surfactants,

ether carboxylates,

anionic surfactants, and

mixtures or associations thereof.

The solvents can be for example:

a water-miscible glycol ether,

a water-miscible alcohol,

a water-miscible ketone

a water-miscible aldehyde

a water-miscible acetate.

Useful solvents include for example:

N-methyl-pyrrolidone (NMP, can be further identified for example with CAS number 872-50-4)

diester solvents,

propylene carbonate,

acetophenone,

ethylene glycol butyl ether,

diethylene glycol butyl ether,

methoxy methyl butanol,

propylene glycol methyl ether,

dipropylene glycol methyl ether,

gamma-butyrolactone,

dimethyl formamide (DMF),

furfuryl alcohol,

tetrahydrofuryl alcohol,

neopentyl glycol,

hexadiols,

hexylene glycol,

glycol ether amines,

ethylene glycol monoacetate, or

a mixture or association thereof.

The composition can for example comprise:

organopolysiloxanes antifoaming agent;

thickening agents such as xanthan gum type polysaccharides, alginates, carboxylated or hydroxylated methylcelluloses, synthetic macromolecules of the polyacrylate, polymaleate, polyvinylpyrrolidone, polyethylene glycol or polyvinyl alcohol type, or of the inorganic type such as bentonites.

auxiliary additives such as antioxidants, anti-UV agents, colorants, etc.

humectants for example glycerin.

### Process

The compositions can be prepared by simply admixing the active, the polycarboxylate, and optionally a liquid medium for example water. Processes for preparing agriculturally active compositions from an active and adjuvants are know by the one skilled in the art.

The composition, when finished, might by filled in containers. According to one embodiment, the final concentration of the composition is monitored directly in the containers by adding some water in said container, up to the desired volume to achieve a desired concentration of active. The containers can for example have a volume allowing from 0.1 L to 10000 L to be filled in, for example 1 L or 10 L or 25 L or 100 L or 1000 L or 5000 L. The containers are then typically charged onto a transportation vehicle, such as a donkey, a truck, a car, a boat, an airplane, a train, and/or a succession thereof, with optional storage, and delivered to a farm. The farmer will then typically dilute it with water in a tank and apply it after dilution.

Use—Process of Use

The composition of the invention can be thus used to treat plants, normally after diluting with water. The diluted composition can be applied onto a field by any appropriate mean.

The dilution, and the application onto the field, can be for example such that the amount of active, for example aminophosphate or amoniphosphonate active in acid or salt form, preferably glyphosate salt, is of from 500 g acid equivalent/ha to 1500 g acid equivalent/ha, typically from 600 to 1200 g/ha. The invention provides a good bioefficacy.

Upon dilution the end-user can admix other herbicides, pesticides, fertilizers, fungicides.

Some details or advantages of the invention will appear in the non-imitative examples below.

### EXAMPLES

### Example 1

### Potassium Glyphosate Composition

A herbicidal composition comprising the following ingredients is prepared in a 100 mL glass container:

| | Composition 1 | | |
|---|---|---|---|
| Ingredient | | Amount as is | Amount as active |

| | | | | |
|---|---|---|---|---|
| Acid Glyphosate 96% | 562.5 | g/L | 540 | g/L |
| KOH 50% | 422.5 | g/L | 211.25 | g/L |
| Viscodis 177 (Coatex) | 160 | g/L | 67.2 | g/L |
| Water | 244 | g/L | | |

The composition presents the following properties:

Amount of Glyphosate: 540 g/L (as acid equivalent)-39.7 wt % (as acid equivalent) of the composition

density at 20° C.: 1.389

Brookfield viscosity: 80 cP (Brookfiled RV 01, 25° C., 20 rpm)

pH (1 wt % solution in water): 5.2

Dilution stability (5 wt % in water, at 20° C., after 2H—CIPAC method MT 41,):

| | | | | |
|---|---|---|---|---|
| Soluble: | A | D | C | 1000 ppm (harder water 1000 ppm Ca, Mg) |

Foaming (CIPAC method MT47):

| time | 10″ | 1′ | 3′ | 12′ |
|---|---|---|---|---|
| Foam | 0 | 0 | 0 | 0 |

Appearance

| | |
|---|---|
| Room temperature | Limpid |
| 7 days at 0° C. | Limpid |
| 14 days at 54° C. | Limpid |
| 7 days at −20° C. | Limpid |

After storage of 14 days at 54° C., the composition presents the following properties:

pH (1 wt % solution in water): 5.2

Dilution stability (5 wt % in water, at 20° C., after 2H—CIPAC method MT 41):

| | | | | |
|---|---|---|---|---|
| Soluble | A | D | C | 1000 ppm |

These results show that the composition has suitable practical properties:

viscosity allows easy handling

no foaming

time stability

good dispersability

Herbicidal activity of the composition is evaluated and accessed as being good.

### Example 2

### Ammonium Gluphosinate Compositions

A herbicidal composition comprising the following ingredients is prepared in a 100 mL glass container:

| | Composition 2.1 | | Composition 2.2 | |
|---|---|---|---|---|
| | Amount | Amount | Amount | Amount |
| Ingredient | as is | as active | as is | as active |
| Ammonium | 300 g/L | 150 g/L | 400 g/L | 200 g/L |
| Gluphosinate 50% | | | | |
| Viscodis 177 | 300 g/L | 126 g/L | 400 g/L | 168 g/L |
| (Coatex) | | | | |
| Water | 534 g/L | | 376 g/L | |

Composition presents the following properties:

| | Composition 2.1 | | | Composition 2.2 | |
|---|---|---|---|---|---|
| density at 20° C. | 1.134 | | | 1.176 | |
| Brookfield viscosity | 20 cP | | | 25 cP | |
| pH (as is) | 7.5 | | | 7.4 | |
| Dispensability | Soluble | A | D | C | 1000 ppm |
| Foaming (CIPAC method | time | 10″ | 1′ | 3′ | 12′ |
| MT47) | Foam | 0 | 0 | 0 | 0 |
| Appearance at room temperature | Limpid | | | | |
| Appearance at 0° C. | Limpid | | | | |
| Appearance at 54° C. | Limpid | | | | |
| Dispersability after storage | Soluble | A | D | C | 1000 ppm |
| of 14 days at 54° C. | | | | | |

These results show that the composition has suitable practical properties:

viscosity allows easy handling

no foaming

time stability

good dispersability

### Example 3

### Isopropylammonium (IPA) Glyphosate Composition

A herbicidal composition comprising the following ingredients is prepared in a 100 mL glass container:

Composition 3

| Ingredient | Amount as is | Amount as active |
|---|---|---|
| IPA Glyphosate | 783 g/L | 360 g/L |
| solution (46%) | | |
| Polycarboxylate¹⁾ | 120 g/L | 52 g/L |
| Water | 277 g/L | |

¹⁾43.5% aqueous solution of Potassium salt of a polycarboxylic acid − Mw = 4500 g/mol

The composition presents the following properties:

Amount of Glyphosate: 360 g/L (as acid equivalent)

density at 20° C.: 1.18

pH (1 wt % solution in water): 5.0

Dilution stability (5 wt % in water, at 20° C., after 2H—CIPAC method MT 41,):

| | | | | |
|---|---|---|---|---|
| Soluble: | A | D | C | 1000 ppm (harder water 1000 ppm Ca, Mg) |

Foaming (CIPAC method MT47):

| time | 10″ | 1′ | 3′ | 12′ |
|---|---|---|---|---|
| Foam | 0 | 0 | 0 | 0 |

Appearance

| | |
|---|---|
| 7 days at 0° C. | Limpid |
| 14 days at 54° C. | Limpid |

After storage of 14 days at 54° C., the composition presents the following properties:

pH (1 wt % solution in water): 5.0

Dilution stability (5 wt % in water, at 20° C., after 2H—CIPAC method MT 41):

| | | | | |
|---|---|---|---|---|
| Soluble | A | D | C | 1000 ppm |

### Example 4

### Isopropylammonium (IPA) Glyphosate Composition

A herbicidal composition comprising the following ingredients is prepared in a 100 mL glass container:

Composition 4

| Ingredient | Amount as is | Amount as active |
|---|---|---|
| Acid Glyphosate 96% | 475 g/L | 450 g/L |
| IPA 70% | 330 g/L | 231 g/L |
| Polycarboxylate¹⁾ | 120 g/L | 52 g/L |
| Water | 275 g/L | |

¹⁾43.5% aqueous solution of Potassium salt of a polycarboxylic acid − Mw = 4500 g/mol

The composition presents the following properties:

Amount of Glyphosate: 450 g/L (as acid equivalent)

density at 20° C.: 1.200

pH (1 wt % solution in water): 5.1

Dilution stability (5 wt % in water, at 20° C., after 2H—CIPAC method MT 41,):

| | | | | |
|---|---|---|---|---|
| Soluble: | A | D | C | 1000 ppm (harder water 1000 ppm Ca, Mg) |

Foaming (CIPAC method MT47):

| time | 10″ | 1′ | 3′ | 12′ |
|---|---|---|---|---|
| Foam | 0 | 0 | 0 | 0 |

Appearance

| | |
|---|---|
| 7 days at 0° C. | Limpid |
| 14 days at 54° C. | Limpid |

After storage of 14 days at 54° C., the composition presents the following properties:

pH (1 wt % solution in water): 5.1

Dilution stability (5 wt % in water, at 20° C., after 2H—CIPAC method MT 41):

| | | | | |
|---|---|---|---|---|
| Soluble | A | D | C | 1000 ppm |

### Example 5

### Potassium Glyphosate Composition

A herbicidal composition comprising the following ingredients is prepared in a 100 mL glass container:

| | Composition 5 | | |
|---|---|---|---|
| Ingredient | | Amount as is | Amount as active |

| | | | | |
|---|---|---|---|---|
| Acid Glyphosate 96% | 562.5 | g/L | 540 | g/L |
| KOH 50% | 422.5 | g/L | 211.25 | g/L |
| Polycarboxylate¹⁾ | 120 | g/L | 52 | g/L |
| Water | 244 | g/L | | |

¹⁾43.5% aqueous solution of Potassium salt of a polycarboxylic acid − Mw = 4500 g/mol

The composition presents the following properties:

Amount of Glyphosate: 540 g/L (as acid equivalent)

density at 20° C.: 1.36

pH (1 wt % solution in water): 5.2

Dilution stability (2 wt % in water, at 30° C., after 2H—CIPAC method MT 41,):

| | | | | |
|---|---|---|---|---|
| Soluble: | A | D | C | 1000 ppm (harder water 1000 ppm Ca, Mg) |

Foaming (CIPAC method MT47):

| time | 10″ | 1′ | 3′ | 12′ |
|---|---|---|---|---|
| Foam | 0 | 0 | 0 | 0 |

Appearance

| | |
|---|---|
| 7 days at 0° C. | Limpid |
| 14 days at 54° C. | Limpid |

After storage of 14 days at 54° C., the composition presents the following properties:

pH (1 wt % solution in water): 5.1

Dilution stability (2 wt % in water, at 20° C., after 2H—CIPAC method MT 41):

| | | | | |
|---|---|---|---|---|
| Soluble | A | D | C | 1000 ppm |

### Example 6

### Ammonium Gluphosinate Compositions

A herbicidal composition comprising the following ingredients is prepared in a 100 mL glass container:

| | Composition 6.1 | | Composition 6.2 | |
|---|---|---|---|---|
| | Amount | Amount | Amount | Amount |
| Ingredient | as is | as active | as is | as active |
| Ammonium | 300 g/L | 150 g/L | 400 g/L | 200 g/L |
| Gluphosinate 50% | | | | |
| Polycarboxylate¹⁾ | 300 g/L | 130.5 g/L | 400 g/L | 174 g/L |
| Water | 534 g/L | | 376 g/L | |

¹⁾43.5% aqueous solution of Potassium salt of a polycarboxylic acid − Mw = 4500 g/mol

The composition presents the following properties:

| | Composition 6.1 | | | Composition 6.2 | |
|---|---|---|---|---|---|
| density at 20° C. | 1.134 | | | 1.176 | |
| Brookfield viscosity | 20 cP | | | 25 cP | |
| pH (as is) | 7.5 | | | 7.7 | |
| Dispensability | Soluble | A | D | C | 1000 ppm |
| Foaming (CIPAC method | time | 10″ | 1′ | 3′ | 12′ |
| MT47) | Foam | 0 | 0 | 0 | 0 |
| Appearance at room temperature | Limpid | | | | |
| Appearance at 0° C. | Limpid | | | | |
| Appearance at 54° C. | Limpid | | | | |
| Dispersability after storage | Soluble | A | D | C | 1000 ppm |
| of 14 days at 54° C. | | | | | |

These results show that the composition has suitable practical properties:

viscosity allows easy handling

no foaming

time stability

good dispersability

1-27. (canceled)

28. An agriculturally active composition comprising:
at least one agriculturally active compound, and
a polycarboxylate compound.

29. The composition of claim 28, wherein the agriculturally active compound comprises a herbicide.

30. The composition of claim 28, wherein the active compound comprises an aminophosphate or an aminophosphonate compound, in an acid or salt form.

31. The composition of claim 30, wherein the aminophosphate or aminophosphonate compound is a salt comprising a cation comprising:
isopropyl ammonium,
potassium
ammonium, or
mixtures or associations thereof.

32. The composition of claim 30, wherein the active compound comprises glyphosate or gluphosinate.

33. The composition claim 32, wherein the active compound comprises potassium glyphosate, isopropyl ammonium glyphosate, or ammonium gluphosinate.

34. The composition of claim 28, wherein said composition comprises a solid or liquid concentrate comprising at least 10% by weight of the at least one active compound.

35. The composition of claim 28, wherein the composition is an aqueous composition comprising the active compound in a solution or suspension form.

36. The composition claim 30, wherein the composition comprises a liquid aqueous concentrate comprising at least 100 g/L as acid equivalent of an aminophosphate or aminophosphonate salt,
further wherein the aminophosphate or aminophosphonate salt is present in solution in the aqueous concentrate.

37. The composition of claim 28, wherein the polycarboxylate comprises a polymer comprising a polymeric backbone and carboxylic side moieties, and
further wherein the carboxylic side moieties comprise an acid, a salt, and/or a condensed anhydride.

38. The composition of claim 37, wherein the polymeric backbone comprises a hydrocarbon chain.

39. The composition of claim 37, wherein a part or all of the carboxylic side moieties comprise a salt comprising sodium and/or potassium cations.

40. The composition of claim 37, wherein the polymer comprises at least 50 mol % of units comprising monomers comprising:
ethylenically unsaturated mono-carboxylic acids, in acid and/or salt form,
ethylenically unsaturated di-carboxylic acids, in acid and/or salt form,
ethylenically unsaturated anhydrides, or
mixtures or associations thereof.

41. The composition of claim 37, wherein the polymer comprises at least 50′ mol % of units comprising acrylic acid and/or methacrylic acid, in acid or salt form.

42. The composition of claim 37, wherein the polymer comprises sodium polyacrylate or potassium polyacrylate.

43. The composition of claim 37, wherein the polymer has a molecular weight ranging from 1 to 5 kg/mol, or from greater than 5 to less than 10 kg/mol, or from 10 to 50 kg/mol, or from greater than 50 to 100 kg/mol, or from greater than 100 to 200 kg/mol, or from greater than 200 to 300 kg/mol, or from greater than 300 to 500 kg/mol, or from greater than 500 to 750 kg/mol, or from greater than 750 to 1000 kg/mol, or from greater than 1000 to 1500 kg/mol, or from greater than 1500 to 2000 kg/mol, or from greater than 2000 to 3000 kg/mol, or from greater than 3000 to 5000 kg/mol, or from greater than 3000 to 5000 kg/mol, or from greater than 5000 to 10000 kg/mol, or is greater than 10000 kg/mol.

44. The composition of claim 28, wherein the weight ratio of the at least one active compound to the polycarboxylate ranges from 1/2 to 100/1.

45. The composition claim 28, wherein the composition is a liquid aqueous concentrate comprising:
at least 360 g/L of aminophosphate or aminophosphonate salt,
at least 20 g/L of the polycarboxylate, and
water.

46. The composition of claim 28, wherein the composition is a liquid aqueous concentrate comprising:
glyphosate salt in an amount ranging from 360 g/L to 560 g/L, and
polycarboxylate in an amount ranging from 20 to 200 g/L.

47. The composition of claim 28, wherein the composition comprises a liquid aqueous concentrate comprising:
gluphosinate salt in an amount ranging from 50 g/L to 300 g/L, and
polycarboxylate in an amount ranging from 20 to 300 g/L.

48. The composition of claim 28, wherein the composition is substantially free of surfactant.

49. The composition of claim 28, further comprising a surfactant.

50. The composition of claim 49, wherein the surfactant comprises:
an optionally polyalkoxylated amine or etheramine surfactant,
a betaine surfactant,
an optionally polyalkoxylated mono or polyglycoside surfactant,
an amine oxide surfactant,
a cationic surfactant,
a phosphate esters surfactant,
an ether carboxylate surfactant,
an anionic surfactant, or
mixtures or associations thereof.

51. The composition claim 28, further comprising:
an anti-foaming agent,
a solvent,
a suspending and/or dispersing agent,
a humectant, and/or
a deposition control agent.

52. A method of making an agriculturally active composition comprising adding a polycarboxylate compound to a composition comprising an agriculturally active compound.

53. The method of claim 52, wherein the agriculturally active compound comprises a herbicide.

54. The method of claim 53, wherein the polycarboxylate compound increases the herbicidal activity of the herbicide.

55. The method of claim 52, wherein the polycarboxylate comprises a polymer comprising a polymeric backbone and carboxylic side moieties, and
further wherein the carboxylic side moieties comprise an acid, a salt, and/or a condensed anhydride.
